(19) United States
(12) Patent Application Publication
(10) Pub. No.: US 2017/0259410 A1
(43) Pub. Date: Sep. 14, 2017

(54) HAND TOOL

(71) Applicant: Tsung-Chih CHANG, Taichung City (TW)

(72) Inventor: Tsung-Chih CHANG, Taichung City (TW)

(21) Appl. No.: 15/069,342

(22) Filed: Mar. 14, 2016

(51) Int. Cl. B25B 17/00; B25B 15/02

(52) U.S. Cl. CPC B25B 17/00; B25B 15/02

(57) ABSTRACT

A hand tool includes a housing defining a receiving space, a shaft rotatably extending through the receiving space and having opposite end portions that are exposed from the housing, a ring-shaped flywheel disposed rotatably in the receiving space and surrounding the shaft, and a speed-increasing gear mechanism. The gear mechanism includes a start gear coupled co-rotatably to the shaft and disposed in the receiving space, at least one transmission gear rotatably disposed in the receiving space and meshing with the start gear, and a final gear coupled co-rotatably to the flywheel, disposed in the receiving space and meshing with the transmission gear. A rotational speed of the final gear is greater than that of the start gear.

### FIELD

The disclosure relates to a hand tool, more particularly to a hand tool that operates with moment of inertia.

### BACKGROUND

Referring to FIG. 1, a conventional hand tool includes a T-shaped main body 2 and a sleeve handle 1. The main body 2 has a handle portion 201, and an operating portion 202 perpendicular to the handle portion 201 and sleeved by the sleeve handle 1. The main body 2 is rotatable relative to the sleeve handle 1.

In an operation of the conventional hand tool, a user holds the sleeve handle 1 with one hand, and holds the handle portion 201 of the main body 2 with the other hand to turn the main body 2. When the user releases the handle portion 201, the main body 2 continues to rotate by a moment of inertia thereof, thereby efficiently fastening or unfastening a threaded fastener (not shown) via a tool head (not shown) which is coupled to the operating portion 202.

However, the handle portion 201, which is necessary for rotating and building a sufficient moment of inertia for the main body 2, renders the conventional hand tool unsuitable for operation in a limited workspace due to possible interference.

### SUMMARY

Therefore, an object of the disclosure is to provide a hand tool that has a relatively compact structure and that can be conveniently used.

According to the disclosure, a hand tool includes a housing that defines a receiving space, a shaft that is connected to the housing and that rotatably extends through the receiving space along an axis, a ring-shaped flywheel that is disposed rotatably in the receiving space and that surrounds the shaft, and a speed-increasing gear mechanism. The shaft has a first end portion exposed from the housing, and a second end portion opposite to the first end portion along the axis and exposed from the housing. The speed-increasing gear mechanism includes a start gear, at least one transmission gear, and a final gear. The start gear is coupled concentrically and co-rotatably to the shaft, and is disposed in the receiving space between the first end portion and the second end portion of the shaft. The at least one transmission gear is rotatably connected to the housing, is disposed in the receiving space, and meshes with the start gear. The final gear is coupled co-rotatably and concentrically to the flywheel, is disposed in the receiving space, and meshes with the transmission gear. A rotational speed of the final gear is greater than that of the start gear.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a conventional hand tool;

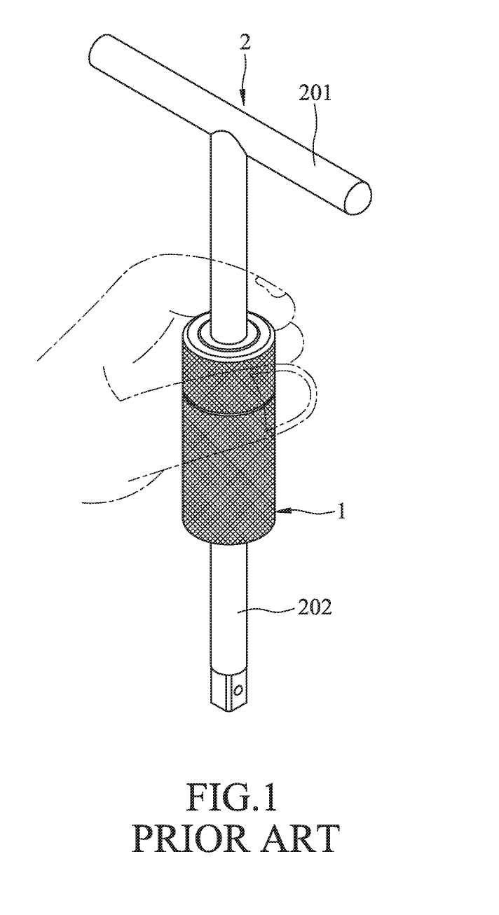

FIG. 2 is a fragmentary partly sectional view illustrating an embodiment of a hand tool according to the disclosure;

FIG. 3 is a fragmentary exploded perspective view of the embodiment;

FIG. 4 is a partly sectional view illustrating a handle of the embodiment being rotated manually by a user; and

FIG. 5 is a view similar to FIG. 4, but illustrating the handle being rotated by a moment of inertia of a flywheel.

### DETAILED DESCRIPTION

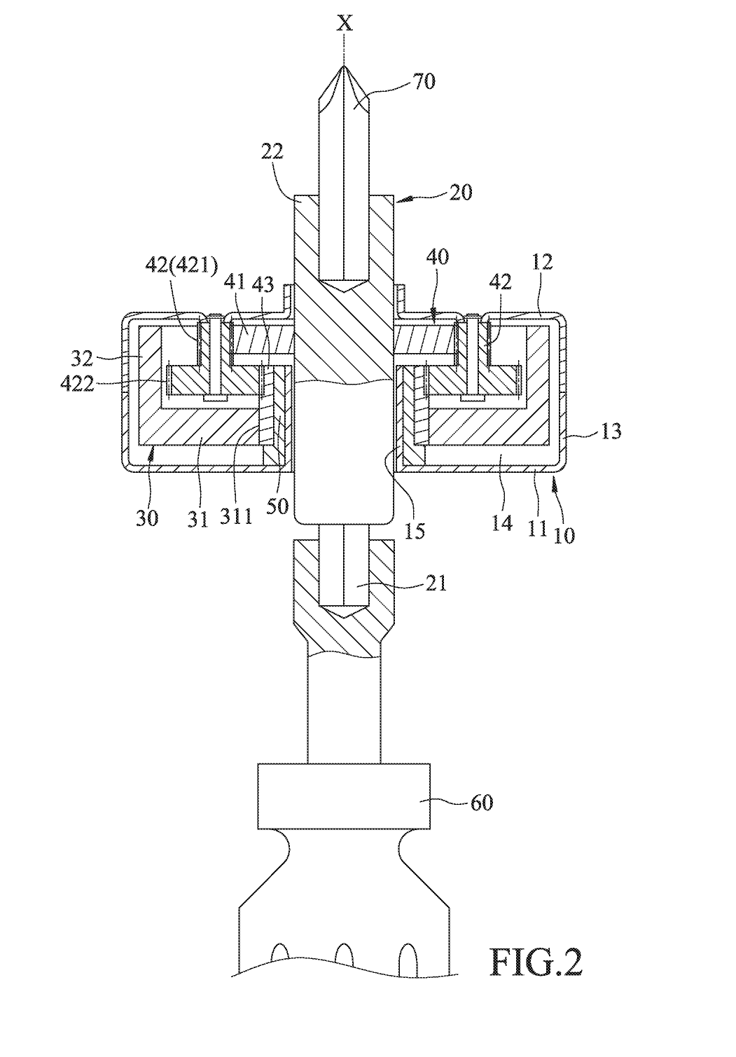

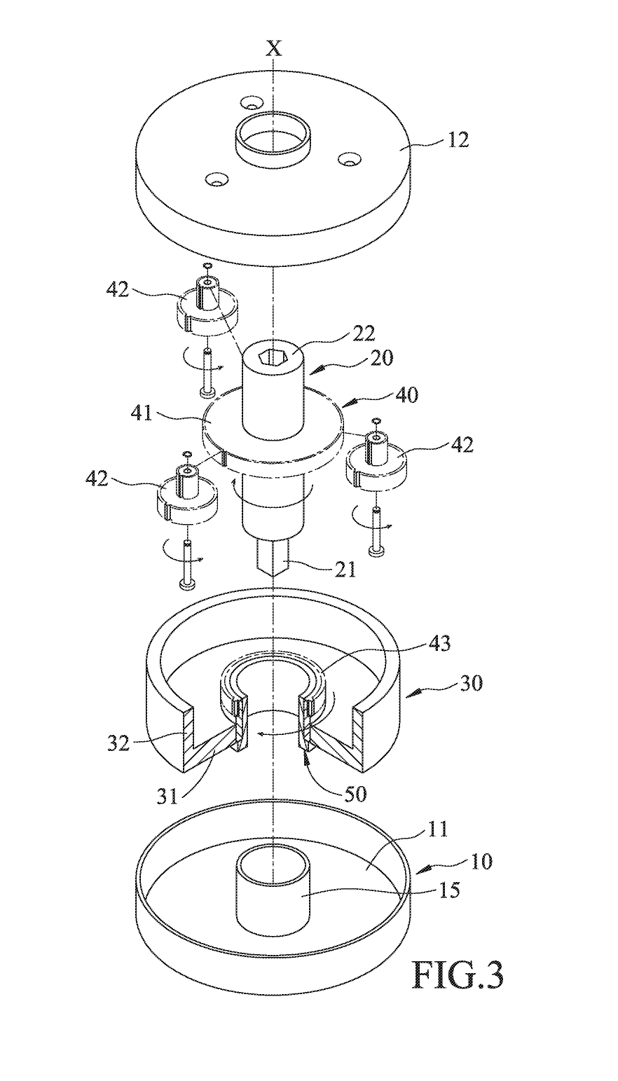

Referring to FIGS. 2 and 3, an embodiment of a hand tool according to the disclosure is illustrated. The hand tool includes a housing 10, a shaft 20, a ring-shaped flywheel 30, a speed-increasing gear mechanism 40, a bearing member 50, a handle 60, and a tool head 70.

The housing 10 has a first ring wall 11, a second ring wall 12 opposite to the first ring wall 11 along an axis (X), a side wall 13 interconnecting outer peripheries of the first and second ring walls 11, 12 and cooperating with the first and second ring walls 11, 12 to define a receiving space 14, and a sleeve 15 extending from an inner periphery of the first ring wall 11 into the receiving space 14.

The shaft 20 is connected to the housing 10, rotatably extends through the receiving space 14 along the axis (X), is surrounded by the sleeve 15, and has a first end portion 21 exposed from the housing 10, and a second end portion 22 opposite to the first end portion 21 along the axis and exposed from the housing 10. In this embodiment, the first and second ends 21, 22 of the shaft 20 are disposed respectively at opposite outer sides of the housing 10 along the axis (X).

The ring-shaped flywheel 30 is disposed rotatably in the receiving space 14, and rotatably surrounds the shaft 20 and the sleeve 15 of the housing 10 (i.e., the sleeve 15 is disposed between the shaft 20 and the flywheel 30). The flywheel 30 has a bottom wall 31 defining a central hole 311 for extension of the shaft 20 therethrough, and a surrounding wall 32 extending along the axis (X) from an outer periphery of the bottom wall 31. The surrounding wall 32 also serves as an add-on mass for the bottom wall 31, thereby resulting in a relatively large moment of inertia for the flywheel 30.

In this embodiment, the speed-increasing gear mechanism 40 includes a start gear 41, a plurality of transmission gears 42, and a final gear 43.

The start gear 41 is coupled concentrically and co-rotatably to the shaft 20, and is disposed in the receiving space 14 between the first end portion 21 and the second end portion 22 of the shaft 2.

The transmission gears 42 are disposed in the receiving space 14 of the housing 10, are rotatably mounted on the second ring wall 12, are surrounded by the surrounding wall 32, and mesh with the start gear 41.

The final gear 43 is coupled co-rotatably and concentrically to the flywheel 30, is disposed in the receiving space 14 of the housing 10, is adjacent to the central hole 311, and surrounds the shaft 20.

Specifically, each of the transmission gears 42 has a first gear portion 421 that meshes with the start gear 41, and a second gear portion 422 that meshes with the final gear 43. The start gear 41 is surrounded by the first gear portions 421 of the transmission gears 42. The final gear 43 is surrounded by and meshes with the second gear portions 422 of the transmission gears 42.

In this embodiment, the first gear portion 421 of each of the transmission gears 42 possesses an outer diameter smaller than that of the start gear 41, so that a rotational speed of the transmission gears 42 is greater than that of the start gear 41. The second gear portion 422 of each of the transmission gears 42 possesses an outer diameter larger than that of the first gear portions 421, and the final gear 43 possesses an outer diameter smaller than that of the start gear 41. Therefore, a rotational speed of the final gear 43 is greater than that of the start gear 41.

In this embodiment, the bearing member 50 is a self-lubricating bearing disposed in the central hole 311 between the sleeve 15 of the housing 10 and the flywheel 30.

In this embodiment, the handle 60 and the tool head 70 are respectively and removably connected to the first and second ends 21, 22 of the shaft 20. The tool head 70 is exemplified as a screwdriver head. It should be noted that, in other embodiments, the first and second ends 21, 22 may be respectively configured as a handle and a tool head (i.e., the shaft 20, the handle 60 and the tool head 70 may be formed as one piece).

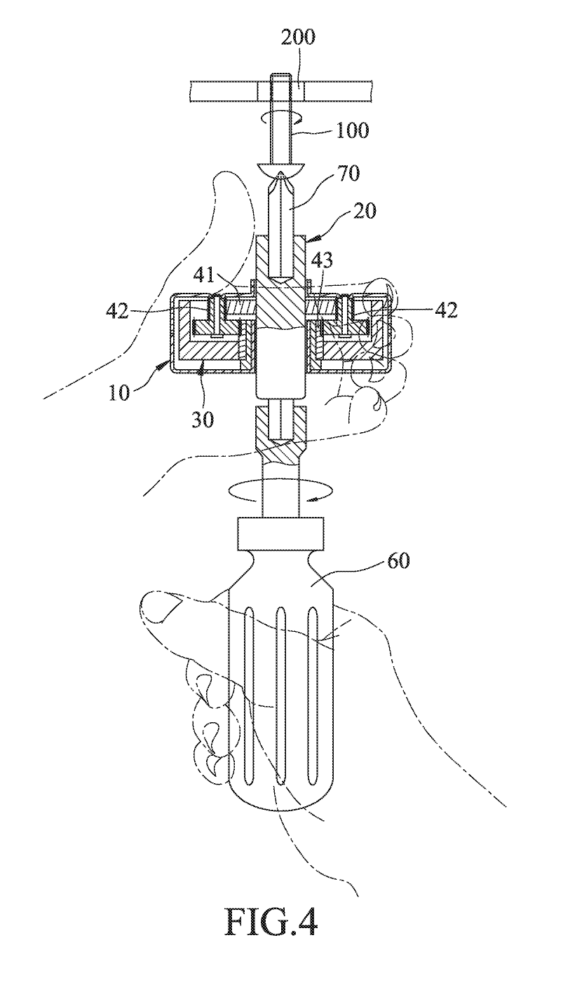

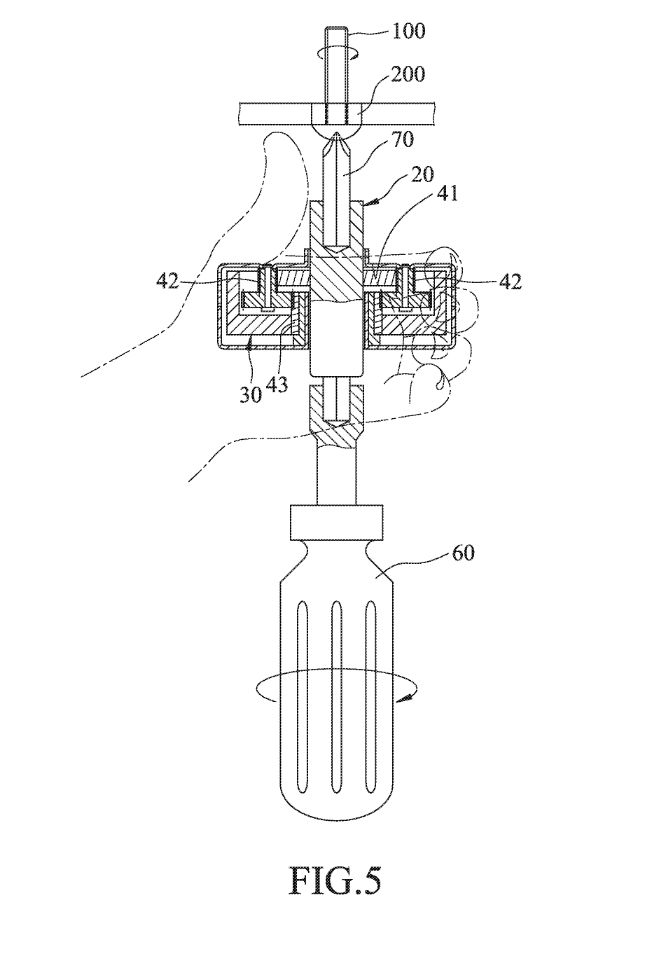

Referring to FIGS. 4 and 5, in an operation of the hand tool according to the disclosure, a user can mate the tool head 70 with a threaded fastener 100, hold the housing 10 with one hand, and turn the handle 60 with the other hand to fasten the threaded fastener 100 on a workpiece 200.

During rotation of the handle 60, the flywheel 30 is driven to rotate by the shaft 20 through the start gear 41, the transmission gears 42 and the final gear 43 of the speed-increasing gear mechanism 40. Then, when the user releases the handle 60 as shown in FIG. 5, the flywheel 30 continues to rotate due to its moment of inertia, thereby driving rotation of the shaft 20 and the tool head 70 via the final gear 43, the transmission gears 42 and the start gear 41 to fasten the thread fastener 100. Similarly, the user can turn the handle 60 in a reverse direction to actuate an automatic reverse rotation of the shaft 20 and the tool head 70 to unfasten the thread fastener 100.

Therefore, by virtue of the speed-increasing gear mechanism 40 and the flywheel 30, the hand tool according to the disclosure can be efficiently operated with the moment of inertia. Moreover, since the speed-increasing gear mechanism 40 increases the rotational speed of the flywheel 30, the flywheel 30 can be made compact and is consequently able to rotate without interference in a limited workspace. In addition, with the transmission gears 42 being retained in the flywheel 30, the size of the flywheel 30 can be further reduced. Furthermore, the surrounding wall 32 increases the total weight of the flywheel 30, thereby further enhancing the moment of inertia of the flywheel 30.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

1. A portion capsule for producing a beverage, having a capsule body with a capsule base and a filling side, wherein a cavity for accommodating a pulverulent, granular or liquid beverage base is formed between the capsule base and the filling side, and wherein a filter element is arranged between the beverage base and the capsule base, wherein the filter element comprises an open-pore felt and/or nonwoven, characterized in that the felt and/or the nonwoven have/has an average first pore size in a first layer which faces the beverage base and an average second pore size in a second layer which faces the capsule base, the first pore size is smaller than the second pore size, the two layers are fixedly connected to one another by welding, wherein the beverage which passes through the filter element expands in the second layer thereby reducing the pressure drop at the surface of the second layer of the filter element which faces the capsule base, wherein the formation of crema in the beverage is essentially prevented when the beverage is extracted in a machine which operates in a pressure range of up to 20 bar.

2. The portion capsule as claimed in claim 1, wherein the filter element has a support layer, wherein the support layer has a different entanglement and/or different fibers and/or fibers with different fiber thicknesses and/or fibers with different thermal treatment on that side which faces the beverage substance and on that side which faces the capsule base.

3. The portion capsule as claimed in claim 1, wherein the first layer of the filter element is a first felt layer and the second layer is a second felt layer.

4. The portion capsule as claimed in claim 3, wherein the felt in the first felt layer is formed from fibers with an average first fiber diameter, and wherein the felt in the second felt layer is formed from fibers with an average second fiber diameter, wherein the first fiber diameter is smaller than the second fiber diameter.

5. The portion capsule as claimed in claim 4, wherein the filter has at least a third felt layer wherein the third fiber diameter is larger than the first fiber diameter and/or smaller than the second fiber diameter.

6. A method for producing a beverage, wherein a portion capsule as claimed in claim 1 is provided in a first step, wherein the portion capsule is inserted into a brewing chamber in a second step, and wherein a preparation liquid is introduced into the portion capsule at a pressure of up to 20 bar in a third step, in order to produce the beverage.

7. (canceled)

8. (canceled)

9. The portion capsule as claimed in claim 1, wherein the felt in the first felt layer is formed from fibers with an average first fiber diameter, and wherein the felt in the second felt layer is formed from fibers with an average second fiber diameter, wherein the first fiber diameter is smaller than the second fiber diameter.

10. The portion capsule as claimed in claim 2, wherein the felt in the first felt layer is formed from fibers with an average first fiber diameter, and wherein the felt the second felt layer is formed from fibers with an average second fiber diameter, wherein the first fiber diameter is smaller than the second fiber diameter.

11. The portion capsule as claimed in claim 1, wherein the pulverulent, granular or liquid beverage base is coffee or tea granules.
